(19) United States
(12) Patent Application Publication
(10) Pub. No.: US 2026/0034664 A1
(43) Pub. Date: Feb. 5, 2026

(54) Grabbing Tool Device

(71) Applicants: Michael Soukup, Phoenix, AZ (US); Anna Marie De Giorgio, Phoenix, AZ (US)

(72) Inventors: Michael Soukup, Phoenix, AZ (US); Anna Marie De Giorgio, Phoenix, AZ (US)

(21) Appl. No.: 19/286,513

(22) Filed: Jul. 31, 2025

Related U.S. Application Data
(60) Provisional application No. 63/678,270, filed on Aug. 1, 2024.

(51) Int. Cl. B25J 1/02

(52) U.S. Cl. CPC B25J 1/02

(57) ABSTRACT

A grabbing tool device is provided. The device is primarily comprised of a first end, a main shaft, a mirror, and a second end and is preferably made from a plastic or lightweight metal material. By pressing a trigger on the handle of the device, a first jaw and a second jaw may close around an arm or control of a vehicle lift. A mirror may be adjusted on the shaft of the device to provide a line of sight to the undercarriage of the vehicle while the operator remains in a standing position. The shaft may further be extendable such that an operator of any height may use the device on any vehicle known in the art.

### CROSS-REFERENCE TO RELATED APPLICATION

The present application claims priority to, and the benefit of, U.S. Provisional Application No. 63/678,270, which was filed on Aug. 1, 2024, and is incorporated herein by reference in its entirety.

### FIELD OF THE INVENTION

The present invention relates generally to the field of grabbing tools. More specifically, the present invention relates to a grabbing tool device that allows a user to manipulate an arm/control of a vehicle lift from a standing position. Accordingly, the present disclosure makes specific reference thereto. Nonetheless, it is to be appreciated that aspects of the present invention are also equally applicable to other like applications, devices, and methods of manufacture.

### BACKGROUND

Working on the undercarriage of a vehicle can be a physically demanding task. During said task, an individual often must get down onto their hands and knees with a bent back, increasing the potential to develop injuries when repeating this process several times. Further, placing an arm of a vehicle lift into the correct position under a vehicle when in this position can be difficult and frustrating, especially when attempting to grab the lift and view the controls.

Therefore, there exists a long-felt need in the art for a device capable of grabbing and manipulating the arms/controls of a vehicle lift. More specifically, there exists a long-felt need in the art for a grabbing tool device that allows a person to operate the controls of a vehicle lift and manipulate vehicle lift arms in a standing position. Furthermore, there exists a long-felt need in the art for a grabbing tool device that allows a user to view the underside of a vehicle from a standing position to adequately place vehicle lift arms onto the vehicle.

The subject matter disclosed and claimed herein, in one embodiment thereof, comprises a grabbing tool device. The device is primarily comprised of a first end, a main shaft, a mirror, and a second end. The device is preferably made from a plastic or lightweight metal material that can extend to the underside of a vehicle. The first jaw and the second jaw may be closed around an arm or control of a vehicle lift by pressing a trigger on a handle of the device. An angled mirror provides the user with a line of sight to the underside of a vehicle, ensuring accuracy when using the device, such that the device may be used with any vehicle or by any operator.

In this manner, the grabbing tool device of the present invention accomplishes all the foregoing objectives and provides a device that allows a user to grab and manipulate the arms/controls of a vehicle lift. Further, the device allows a user to do so in a standing position. The device also allows a user to view the underside of a vehicle from a standing position to adequately place vehicle lift arms onto the vehicle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a grabbing tool device primarily comprised of a first end comprised of a handle, a main shaft, a mirror, and a second end comprised of a first jaw and a second jaw. The device is designed to grab onto and operate the controls and/or lift arms of a vehicle lift while allowing a user to remain in an upright, standing position when doing so.

The device is preferably made of a metal or plastic material and is comprised of a first end. The first end is further comprised of a handle which is comprised of a trigger. The trigger may be squeezed closed to close the jaws of the device. The handle is fixedly attached to a main shaft. In one embodiment, a secondary shaft may telescope out from the main shaft, allowing the length of the device to be changed according to the needs of a user. The length of the secondary shaft may be fixed by tightening a locking mechanism on the main shaft. A mirror may be attached to the secondary shaft via an arm to allow a user to view the undercarriage of a vehicle from a standing position to position vehicle lift arms appropriately.

The secondary shaft may be fixedly attached to a second end of the device. The second end of the device is further comprised of a first jaw and a second jaw that may open and close by manipulation of the trigger. More specifically, when the trigger is squeezed, a jaw mechanism attached to the trigger and to the jaws, tightens. This causes the first jaw and the second jaw to close about a hinge point of the second end. When positioned accordingly, the first jaw and the second jaw may close around an arm or other control point of a vehicle lift to reposition the arms or operate the controls of the vehicle lift.

The present invention is also comprised of a method of using the device. First, a device is provided comprised of a first end, a main shaft, a mirror, and a second end. Then, a user grips a handle of the device and positions the first jaw and the second jaw of the second end around an arm or control of the vehicle lift. Then, the user squeezes a trigger to close the first jaw and the second jaw of the second end together, closing around the arms of the vehicle lift. Next, the user may move the device to reposition the vehicle lift to the proper position by looking at the reflection of a mirror. Then, the trigger may be released, opening the first jaw and the second jaw of the second end, and removing the device from under the vehicle.

Accordingly, the grabbing tool device of the present invention is particularly advantageous as it provides a device that allows a user to grab and manipulate the arms/controls of a vehicle lift. Further, the device allows a user to do so in a standing position. The device also allows a user to view the underside of a vehicle from a standing position to adequately place vehicle lift arms onto the vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a grabbing tool device of the present invention in accordance with the disclosed architecture;

FIG. 2 illustrates an enhanced view of a second end of one potential embodiment of a grabbing tool device of the present invention in accordance with the disclosed architecture;

FIG. 3 illustrates a perspective view of a user using one potential embodiment of a grabbing tool device of the present invention with a vehicle lift and vehicle in accordance with the disclosed architecture; and

FIG. 4 illustrates a flowchart of a method of using one potential embodiment of a grabbing tool device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device capable of grabbing and manipulating the arms/controls of a vehicle lift. More specifically, there exists a long-felt need in the art for a grabbing tool device that allows a person to operate the controls of a vehicle lift and manipulate vehicle lift arms in a standing position. Furthermore, there exists a long-felt need in the art for a grabbing tool device that allows a user to view the underside of a vehicle from a standing position to adequately place vehicle lift arms onto the vehicle.

The present invention, in one exemplary embodiment, is comprised of a grabbing tool device. The device is primarily comprised of a first end, a main shaft, a mirror, and a second end. The device is designed to grab onto and operate the controls/arms of a vehicle lift while allowing a user to remain in an upright, standing position.

More specifically, the device is preferably made of a metal or semi-flexible plastic material. The device is comprised of a first end, further comprised of a handle. The handle acts as a contact point in which a user may operate the device. The handle is further comprised of a grip and a trigger. The grip of the handle provides a comfortable location for a user to grip the device. The trigger may be squeezed and closed to operate the device.

Fixedly attached to the handle is a main shaft. In one potential embodiment, the main shaft may be comprised of a secondary shaft that is extendable by telescoping out from the main shaft. The length of the extension of the secondary shaft may be fixed by tightening a locking mechanism between the main shaft and the secondary shaft. The main shaft may also be fixedly attached to a second end of the device. However, in the embodiment of the device in which the secondary shaft telescopes out from the main shaft, the second end may be fixedly attached to the secondary shaft. The main shaft is further comprised of a jaw mechanism that is connected to the trigger of the handle. The jaw mechanism is preferably a spring that runs the inside of the length of the main shaft and the secondary shaft to connect to a hinge point of a second end. In addition, a mirror may be attached to either the main shaft or the secondary shaft close to the second end via an arm. The arm may be rigid or flexible such that it can be repositioned to the preference of the user.

The second end is comprised of a first jaw and a second jaw. Each of the first jaw and the second jaw are attached to the hinge point of the second end. The first jaw and the second jaw may default to an open position. When the trigger of the handle is closed, the first jaw and the second jaw rotate about the hinge point of the second end, closing the first jaw and the second jaw such that a tip of the first jaw connects to a tip of the second jaw. The first jaw and the second jaw may be closed around an arm or control mechanism of a vehicle lift to reposition the vehicle lift to the correct position underneath the vehicle. Both the tip of the first jaw and the tip of the second jaw may be made of a differing material from the device, such as rubber, to provide additional grip to the first jaw and the second jaw of the device.

The present invention is also comprised of a method of using the device. First, a device is provided comprised of a first end, a main shaft, a mirror, and a second end. Then, a user grips a handle of the device and positions the first jaw and the second jaw of the second end around an arm of the vehicle lift. Then, the user squeezes a trigger to close the first jaw and the second jaw of the second end together, closing around the arms of the vehicle lift. Next, the user may move the device to reposition the vehicle lift to the proper position by looking at the reflection of a mirror. Then, the trigger may be released, opening the first jaw and the second jaw of the second end and removing the device from under the vehicle.

Accordingly, the grabbing tool device of the present invention is particularly advantageous as it provides a device that allows a user to grab and manipulate the arms/controls of a vehicle lift. Further, the device allows a user to do so in a standing position. The device also allows a user to view the underside of a vehicle from a standing position to adequately place vehicle lift arms onto the vehicle.

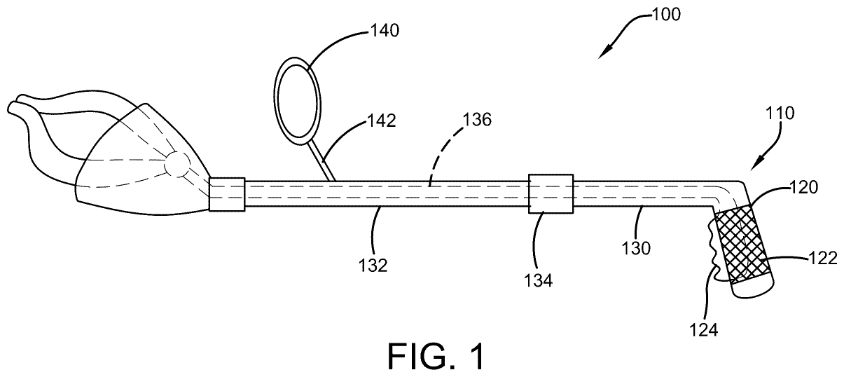

Referring initially to the drawings, FIG. 1 illustrates a side view of one potential embodiment of a grabbing tool device 100 of the present invention in accordance with the disclosed architecture. The device 100 is primarily comprised of a first end 110, a main shaft 130, a mirror 140, and a second end 150. The device 100 is designed to grab onto and operate the arms 12 and other controls of a vehicle lift 10 while allowing a user to remain in an upright, standing position.

The device 100 is preferably made of a lightweight metal, such as aluminum, or a flexible or semi-flexible plastic material. However, the device may be made from any material known in the art. The device 100 is comprised of a first end 110 further comprised of a handle 120. During use, a user may grab onto the handle 120 while operating the device 100. The handle 120 is further comprised of at least one grip 122 and at least one trigger 124. The grip 122 of the handle 120 may be made of a differing material than the device 100, such as rubber, to provide additional stability to the grip of the user. In addition, the grip 122 of the handle 120 may be comprised of a raised or recessed texture to aid in grip or to ergonomically fit the contours of a human hand. The trigger 124 of the handle 120 may be squeezed closed to operate the device 100.

The handle 120 is fixedly attached to a main shaft 130. In one potential embodiment, at least one secondary shaft 132 may fit inside of the main shaft 130 such that it can telescope outwards from the main shaft 130 to accommodate the height of different individuals operating the device 100. The combined length of the main shaft 130 and the secondary shaft 132 may be fixed by tightening at least one locking mechanism 134 between the main shaft 130 and the secondary shaft 132. The locking mechanism 134 may be any type known in the art and may secure the length of the secondary shaft by twisting a lock, pressing a button, closing a hinge, etc.

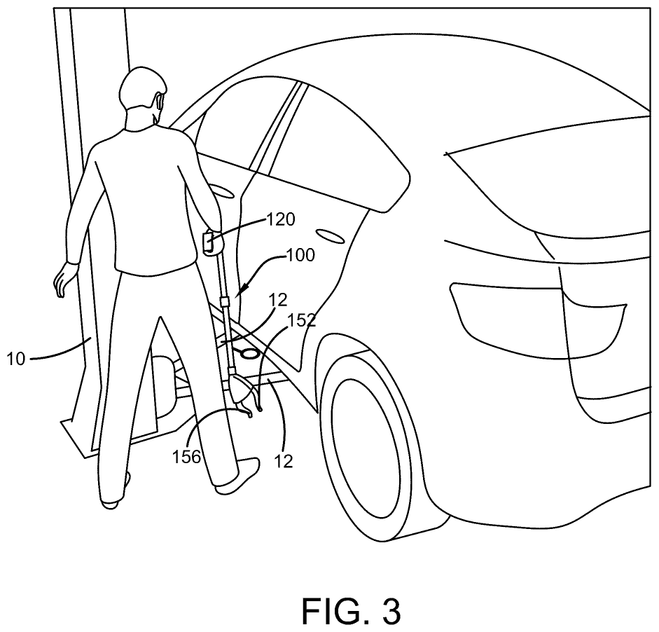

At least one mirror 140 may be fixedly or removably attached near the end of the secondary shaft 132 via at least one arm 142. The arm 142 may be rigid or flexible such that a user can reposition the mirror 140 during use. The mirror 140 allows a user to see different parts of the undercarriage of a vehicle while standing, as best seen in FIG. 3. This allows the user to position the vehicle lift arms 12 appropriately. The mirror 140 may be concave or convex in different embodiments.

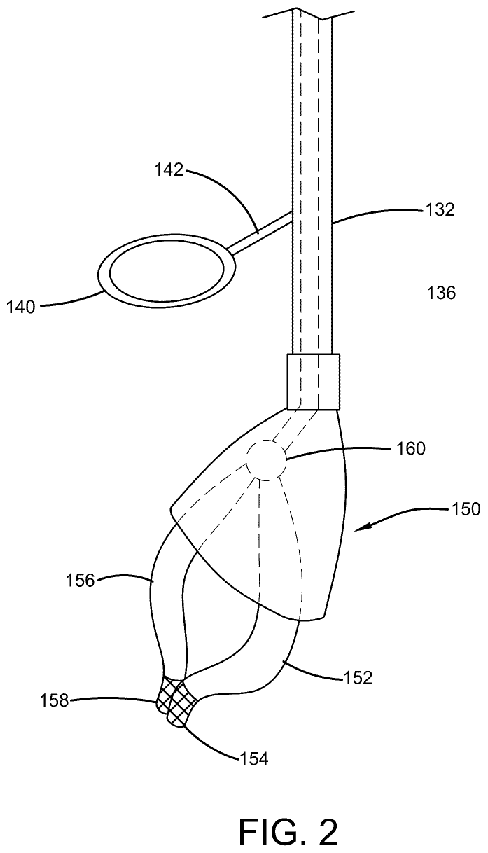

FIG. 2 illustrates an enhanced view of a second end 150 of one potential embodiment of a grabbing tool device 100 of the present invention in accordance with the disclosed architecture. The second end 150 may be comprised of a first jaw 152 and a second jaw 156 attached to the main shaft 130 (or secondary shaft 132 in any embodiment where the device 100 is comprised of a secondary shaft 132). The first jaw 152 and the second jaw 156 default to an open position. When the trigger 124 of the handle 120 is squeezed (i.e., depressed), a jaw mechanism 136 (preferably but not limited to a spring) connected to the trigger 124 and jaws 152,156 cause the first jaw 152 and the second jaw 156 to rotate about at least one hinge point 160 to close the jaws 152,156. The first jaw 152 and the second jaw 156 may rotate towards each other to close around the arms 12 of a vehicle lift 10 or other controls such that the arms 12 of the vehicle lift 10 may be repositioned. A tip 154 of the first jaw 152 and a tip 158 of the second jaw 156 may also be comprised of a differing material, such as rubber, that is textured to provide an enhanced grip onto whatever object the first jaw 152 and the second jaw 156 are grabbing, manipulating, touching, etc.

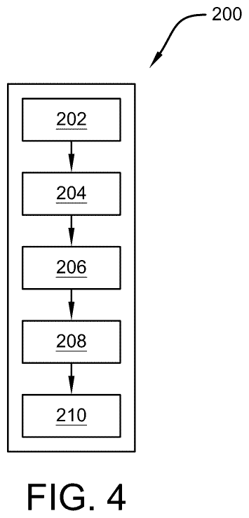

The present invention is also comprised of a method 200 of using the device 100, as seen in FIG. 4. First, a device 100 is provided comprised of at least one trigger 124, a main shaft 130, at least one mirror 140, and a first jaw 152 and a second jaw 156 [Step 202]. Then, a user grips a handle 120 of the device 100 and positions the first jaw 152 and the second jaw 156 of the second end 150 around an arm 12 of the vehicle lift 10 (or on a control of the lift 10) [Step 204]. Then, the user squeezes a trigger 124 of the handle 120 to close the first jaw 152 and the second jaw 156 of the second end 150 together, closing around the arms 12 of the vehicle lift 10 [Step 206]. Next, the user may move the device 100 to reposition the vehicle lift 10 arms 12 to the proper position underneath the vehicle, while also looking at the undercarriage of the vehicle via the mirror 140 to correctly position the arms 12 [Step 208]. Then, the trigger 124 may be released, opening the first jaw 152 and the second jaw 156 of the second end 150 and removing the device 100 from under the vehicle [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “grabbing tool device” and “device” are interchangeable and refer to the grabbing tool device 100 of the present invention.

Notwithstanding the foregoing, the grabbing tool device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the grabbing tool device 100 as shown in the FIGS. are for illustrative purposes only, and that many other sizes and shapes of the grabbing tool device 100 are well within the scope of the present disclosure. Although the dimensions of the grabbing tool device 100 are important design parameters for user convenience, the grabbing tool device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A grabbing tool device comprising:
a handle comprised of a trigger;
a shaft comprised of a mirror attached to the shaft via an arm;
a first jaw and a second jaw connected by a hinge point; and
a jaw mechanism attached to the hinge point and the trigger.

2. The grabbing tool device of claim 1, wherein the arm is comprised of a rigid arm.

3. The grabbing tool device of claim 1, wherein the handle is comprised of a grip area.

4. The grabbing tool device of claim 3, wherein the grip area is comprised of a raised or a recessed texture.

5. The grabbing tool device of claim 1, wherein the jaw mechanism is comprised of a spring.

6. The grabbing tool device of claim 1, wherein the mirror is comprised of a concave or a convex mirror.

7. A grabbing tool device comprising:
a handle
a trigger positioned on the handle;
a telescopic shaft comprised of a main shaft and a secondary shaft;
a mirror attached to the telescopic shaft via an arm;
a first jaw and a second jaw connected by a hinge point; and
a jaw mechanism attached to each of the hinge point and the trigger.

8. The grabbing tool device of claim 7, wherein the arm is comprised of a flexible arm.

9. The grabbing tool device of claim 7, wherein the jaw mechanism is comprised of a spring.

10. The grabbing tool device of claim 7, wherein the telescoping shaft is comprised of a locking mechanism.

11. The grabbing tool device of claim 10, wherein the locking mechanism locks the position of the secondary shaft relative to the main shaft.

12. The grabbing tool device of claim 7, wherein the first jaw is comprised of a first tip and the second jaw is comprised of a second tip.

13. The grabbing tool device of claim 12, wherein the first tip is comprised of a textured rubber material.

14. The grabbing tool device of claim 12, wherein the second tip is comprised of a textured rubber material.

15. The grabbing tool device of claim 7, wherein the jaw mechanism is comprised of a spring.

16. The grabbing tool device of claim 7, wherein the handle is comprised of a grip area.

17. The grabbing tool device of claim 16, wherein the grip area is comprised of a raised or a recessed texture.

18. The grabbing tool device of claim 7, wherein the mirror is comprised of a concave or a convex mirror.

19. A method of using a grabbing tool device, the method comprising the following steps:
providing a grabbing tool device comprised of a trigger, a main shaft, a mirror, and a first jaw and a second jaw;
gripping a handle of the grabbing tool device and positioning the first jaw and the second jaw around an arm of a vehicle lift;
squeezing the trigger to close the first jaw and the second jaw together around the arm;
moving the device to reposition the arm to a position underneath a vehicle while looking at the undercarriage of the vehicle via the mirror to correctly position the arm; and
releasing the trigger and removing the device from under the vehicle.

20. The method of claim 19 further comprised of a step of positioning the first jaw and the second jaw around a control of the vehicle lift.
